(19) United States
(12) Patent Application Publication
(10) Pub. No.: US 2008/0300001 A1
(43) Pub. Date: Dec. 4, 2008

(54) Wireless indicator assisted method for locating library items

(76) Inventors: Areeb Ahmed Siddiqui, Plano, TX (US); Aqeel Ahmed Siddiqui, Plano, TX (US)

Correspondence Address: Areeb Ahmed Siddiqui, 3425 Bluegrass Dr, Plano, TX, 75074, US

(21) Appl. No.: 11/807,370

(22) Filed: May 29, 2007

(51) Int. Cl. H04B 7/26

(52) U.S. Cl. 455/500

(57) ABSTRACT

A method where a library user is guided to the searched item by providing directions towards the searched item. The directions may be provided by an online map or by a hand held device. An electronic device is mounted on the searched item that receives signals via a wireless network and turns on an indicator. This indicator helps the users in locating the item.

### CROSS REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

The present invention relates to locating items in a library. More particularly, and not by way of limitation, the present invention is directed to a system and method for providing audible and/or visual directions to library users for physical location of items.

Currently the most common method is by labeling the library items with a unique code that is composed of numbers and characters. The items are arranged in shelves in an order. The racks are labeled with the range of numbers and/or characters of contained items. Then within the shelves the items are arranged in an order. For library users it takes often longer time to find the items. It is particularly inconvenient for handicap users and children.

### BRIEF SUMMARY OF THE INVENTION

Each library item shall be equipped with an electronic visual indicator, for example an LED (light emitting device). In addition there will be a receiver associated with each item. The receiver will be used to receive wireless signals for turning the visual indicator on or off. When a user wishes to locate an item in the library, the visual indicator on the item is turned on. This helps the user in finding the item.

Alternatively, the library will have portable devices for guiding user to the searched items. When a user wishes to locate an item in the library, the user will walk with portable device in his/her hand. The portable device will guide the user to the searched item using audio and/or visual messages.

Once this new art is implemented, there will be no need to arrange the library items in any order. Thus the library items will be able to be re-shelved much easier and in a relatively short amount of time.

### BRIEF DESCRIPTION OF THE DRAWINGS

A more complete understanding of the method and arrangement of the present invention may be had by reference to the following detailed description when taken in conjunction with the accompanying drawings wherein:

FIG. 1 depicts library item pointed by visual indicator after it is searched. The computer terminal indicates the user the isle in which the item is located.

FIG. 2 depicts the use of a hand-held portable device in locating the library item in addition to the visual indicator on the library item.

### DETAILED DESCRIPTION OF THE INVENTION

As will be recognized by those skilled in the art, the innovative concepts described in the present application can be modified and varied over a wide range of applications. Accordingly, the scope of patented subject matter should not be limited to any of the specific exemplary teachings discussed here.

There will be a wireless signal broadcasting system installed at the library. The computers at the library will be connected to this broadcasting system. Each library item will have a wireless receiver and an indicator. The indicator can be visual, audio, vibration, or a combination of these.

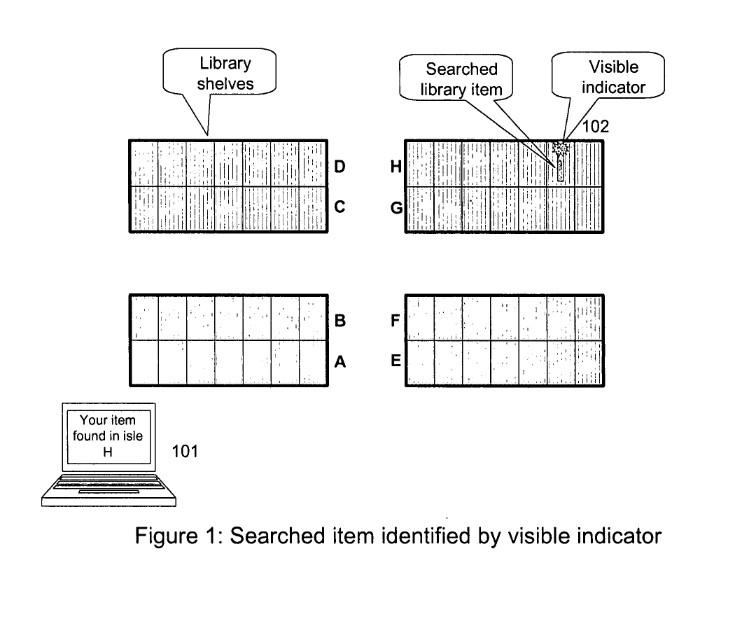

FIG. 1 depicts library item pointed by indicator after it is searched. The user first searches the item on a computer terminal in the library. Once the item is found and the user clicks on the ‘locate item’ hypertext link, the computer displays the isle in which the item is located (step 101). Then the computer sends a signal through the Wireless Local Area Network (WLAN) to the searched item to turn on the indicator (step 102). When the user walks to the isle where the item is located, the item is easily found due to the indicator. There are several ways in which the indicator can be reset after that. There can be a small reset button on the item or there can be a timeout after which the indicator is automatically reset. Alternatively, the library item may have a sensor, which detects when the item is removed from its location, in which case the visual indicator is turned off.

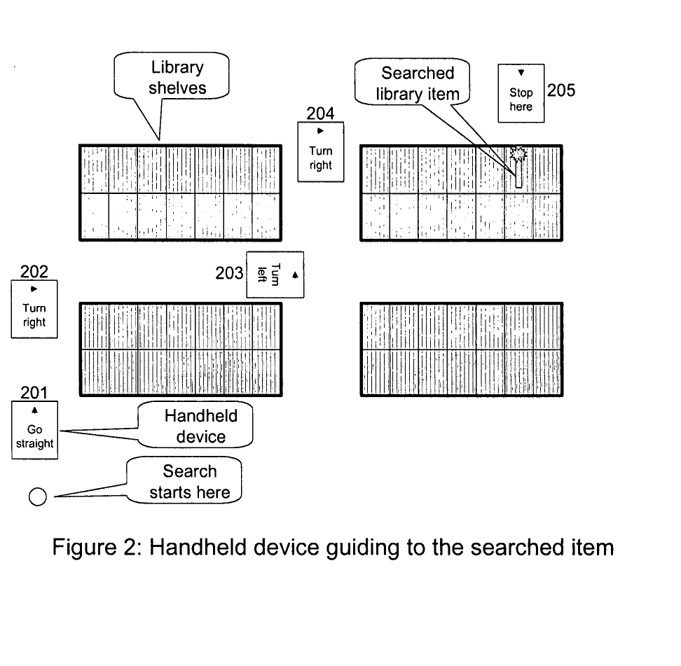

FIG. 2 depicts the use of a hand-held portable device in locating the library item. The user either searches a library item via a hand-held portable device or via a computer terminal adjacent to the hand-held portable device. Once the item is found to be available and the user has clicked on the hypertext link ‘locate item’, the portable device will guide the user to the item by visual (e.g. arrows) or audio (e.g. “turn right”, “go straight”, etc.) signals to the item (see steps 201-205). An indicator located on the searched item is also turned on through the WLAN. The strength of the signal may increase as the user gets closer to the item until it is found. When the portable device is near the item, a visual, audio, or physical (e.g. vibrator) signal will indicate the presence of the item nearby. The indicator on the item can then be reset by a suitable mechanism as described earlier.

What is claimed:

1. A method for guiding a library user to the searched item by turning on an electronic indicator on the searched item.

2. The method of claim 1, wherein the electronic indicator on the searched item can be visual, audio, vibration, or any combination of these.

3. The method of claim 1, wherein the guidance can be provided by a hand held device, which tracks its location within the library, as the user moves towards the searched item, and provides visual and or audio signals to the user before each turn that the user needs to make.
